(19) United States
(12) Patent Application Publication
(10) Pub. No.: US 2004/0085044 A1
(43) Pub. Date: May 6, 2004

(54) Socket for charging device

(76) Inventor: Man Ho Yang, Hong Kong (CN)

Correspondence Address: Marlana Titus, Nash & Titus, LLC., 605 Riggs Road, Laytonsville, MD, 20882, US

(21) Appl. No.: 10/472,135

(22) PCT Filed: Jun. 18, 2002
(86) PCT No.: PCT/IB02/02242

(30) Foreign Application Priority Data
Jun. 19, 2001 (CN) 01 2 42225.8

(51) Int. Cl. H02J 7/00

(52) U.S. Cl. 320/112

(57) ABSTRACT

The invention relates to a charging socket for a flashlight with a slot (7) in the socket body (1), in which an electric conducting pin (3), which is connected electrically to an electric conducting plate (2) affixed in the body (1), and an earth plate (4) are located.

The invention relates to a charging socket for a flashlight.

Flashlights can be re-charged by a simple and reliable means with the assistance of charging sockets.

Conventional, familiar flashlights which have been tried and tested in daily private and working life have the disadvantage that their lifetime is limited, due to the fact that the capacity of the flashlight batteries is restricted. Another point is that disposable batteries cause substantial pollution to the environment. It is for this reason that re-chargeable batteries which can be removed from the flashlight and re-charged in a charging device are in use on an increasing scale. With some flashlights, the re-chargeable batteries do not have to be removed. These flashlights contain a charging socket in the flashlight body. The battery can thus be easily re-charged by connecting the charging plug with the charging socket. A charging socket and a corresponding plug pursuant to Fig a are known for their direct-current use. The plug A is connected to the sleeve B and can, in time, become loose. The charging socket has a contact C, a spring contact D and an earth contact E. If the socket F is inserted into the socket A in slanting fashion, a short circuit is created between the positive plug contact G and the negative plug contact H.

The task of the invention is to provide an improved charging socket.

The particular task of the invention at issue is to provide a charging socket which is less prone to producing short circuits.

The charging socket according to the invention has a slot in the socket body. The slot contains an electric conducting pin, which is connected electrically with an electric conducting plate, and an earth plate.

The electric conducting pin is intended to accommodate the corresponding charging plug of a charging device. Preferably, two ends of the electric conducting plate protrude from two walls of the socket body. At best, the socket body has a wall on the side of the flashlight body and a wall on the side of the flashlight head. These two walls are positioned transversally, at best vertically to two side walls of the slot. The walls on the flashlight body side and the flashlight head side are, at best, also arranged transversally in longitudinal direction to the flashlight. One end of the electric conducting plate protrudes from the wall at the flashlight body side and the other end of the electric conducting plate protrudes from the wall at the flashlight head side. The two ends are positioned in such a manner that one end has contact to a pole of the flashlight battery and the other end of the electric conducting plate has contact to a connection to a switch.

At best, the slot has two side walls which run in longitudinal direction to the flashlight. The two side walls can be positioned more closely to each other at the opening of the slot than on the inner side.

A support for the earth plate can be located between the two walls of the slot. Preferably, the earth plate is in the form of a curved metal strip, one end of which protrudes from the slot at the side of the opening and is curved, and the other end is located in the slot and the strips have curved-in rims. The other end contains a spring pointing towards the pin. The thus curved metal strip can be propped up by the support.

Preferably, the slot is of such a design that the electric conducting pin is located next to the earth plate. As a result, a charging current can be switched on by inserting a corresponding charging plug. A particularly favourable form of the charging socket is where the socket body is injection moulded. This type is reasonably-priced and easy to manufacture.

During the injection moulding procedure, the electric conducting pin and the electric conducting plates can be inserted into the body.

The task is also solved through a flashlight with a flashlight body which has a socket opening and a charging socket located at the flashlight body side pursuant to one or more of the aforementioned designs, which is designed in such a manner that the slot opening and the plug opening are arranged one above the other, when one end of the electric conducting plate is connected electrically to a flashlight battery pole of a suitable flashlight battery, and the other end of the electric conducting plate is electrically connected to a flashlight switch. Preferably, the charging socket can be in module form and capable of insertion into a flashlight. The slot opening and plug opening correspond to each other and enable the insertion of the charging plug. At best, the electric conducting pin and the earth plate are arranged in such a manner that the corresponding charging plug inserted switches on a second electric circuit for charging the flashlight batteries via the earth plate of the electric conducting pin and the electric conducting plate. In this manner, the flashlight can be operated simultaneously during the charging process, and even if the charging plug is inserted in a slanting fashion, no short circuit is created as a result of the separation of the electric conducting pin and the earth plate.

The invention is described with the assistance of 10 figures by way of example as follows:

Fig a charging socket according to the state of the art

FIG. 1 cross-section diagram from the side of charging socket according to the invention

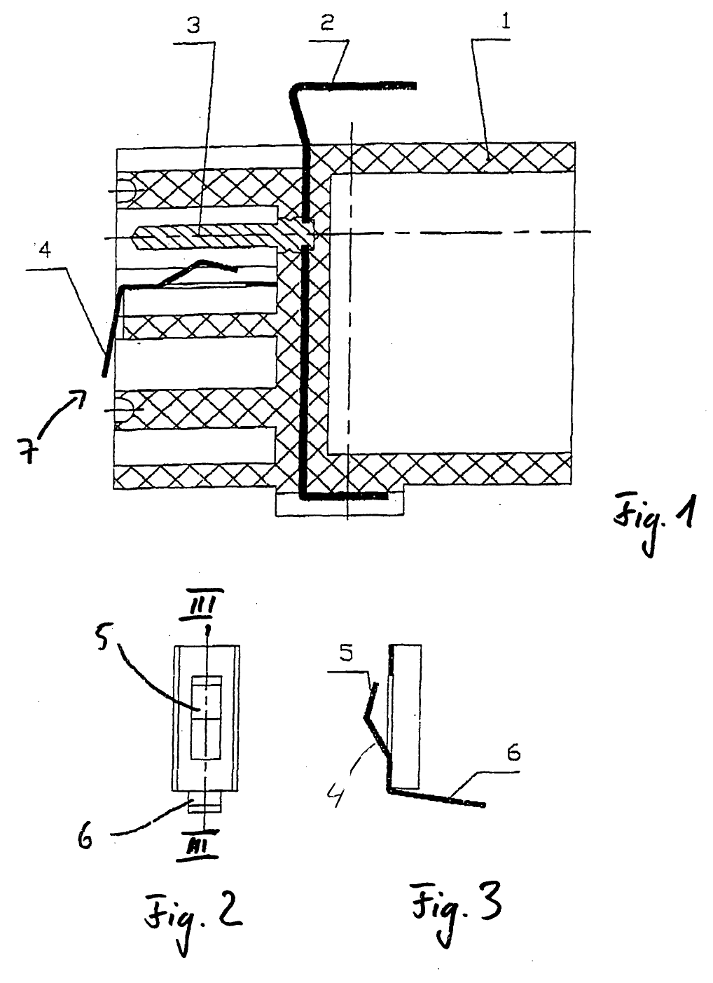

FIG. 2 front view of an earth plate

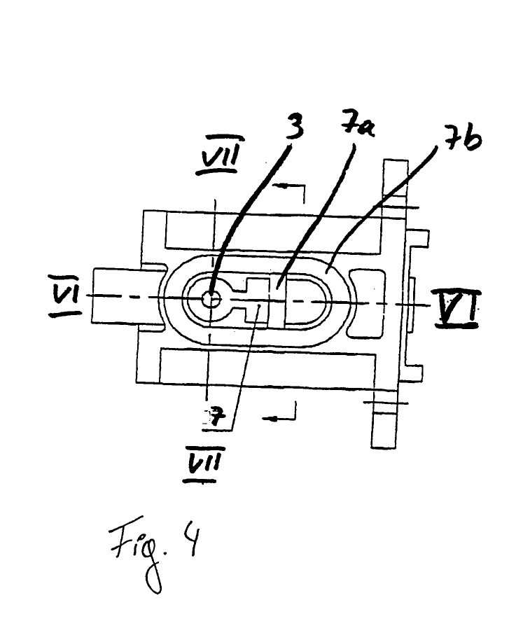

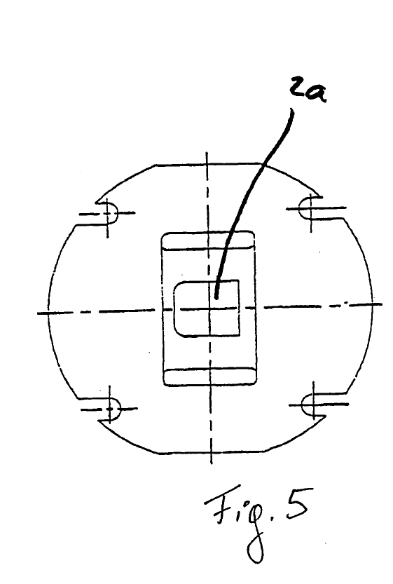

FIG. 3 cross-section view of the earth plate along line III-III in FIG. 2

FIG. 4 view of opening side of charging socket

FIG. 5 view of charging socket from flashlight body side

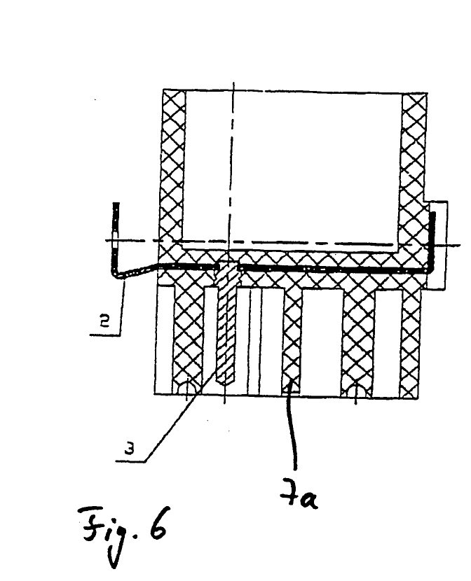

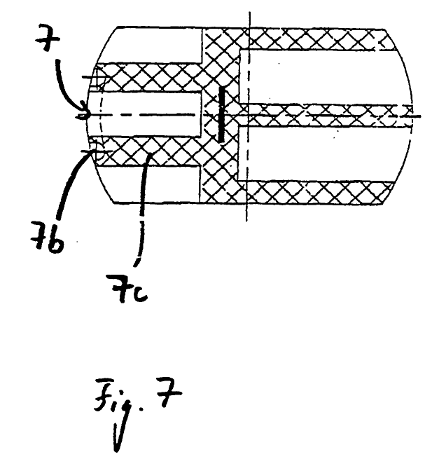

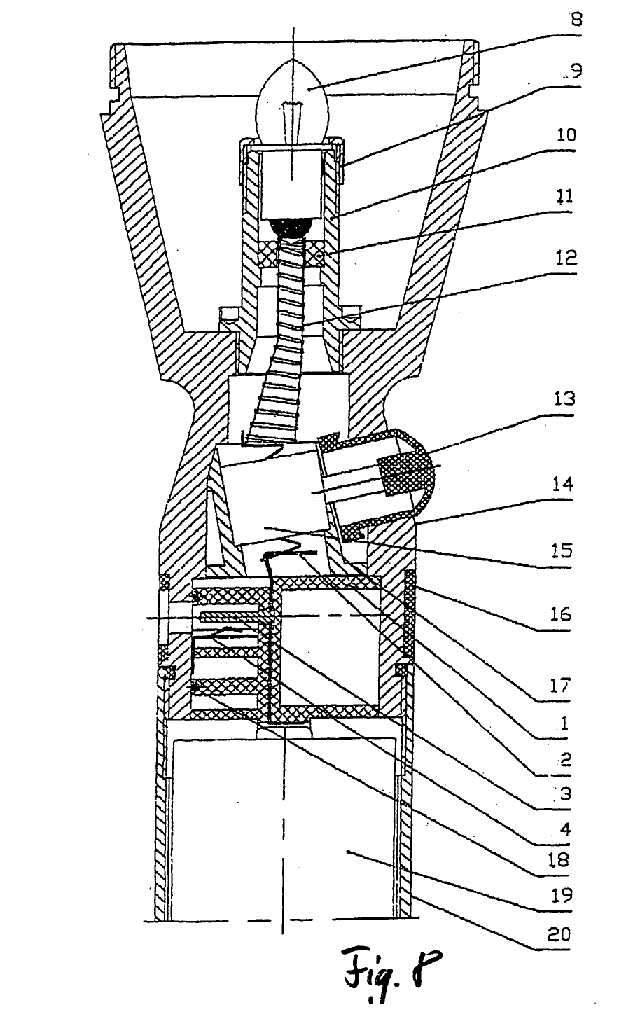

FIG. 6 charging socket along line VI-VI in FIG. 4

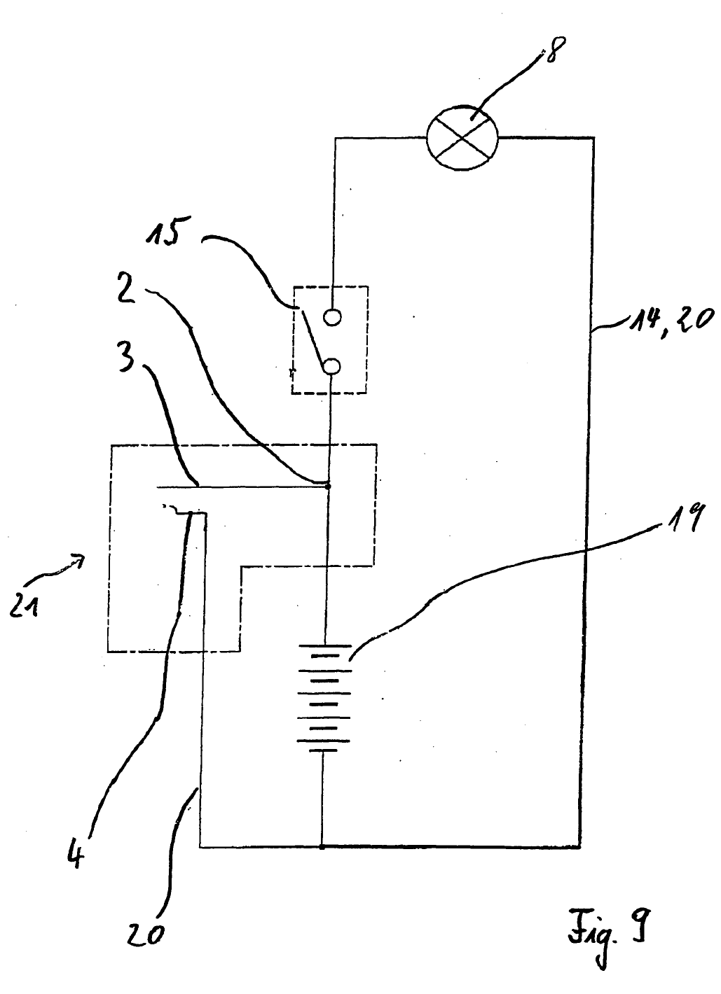

FIG. 7 cross-section diagram along line VII-VII in FIG. 4

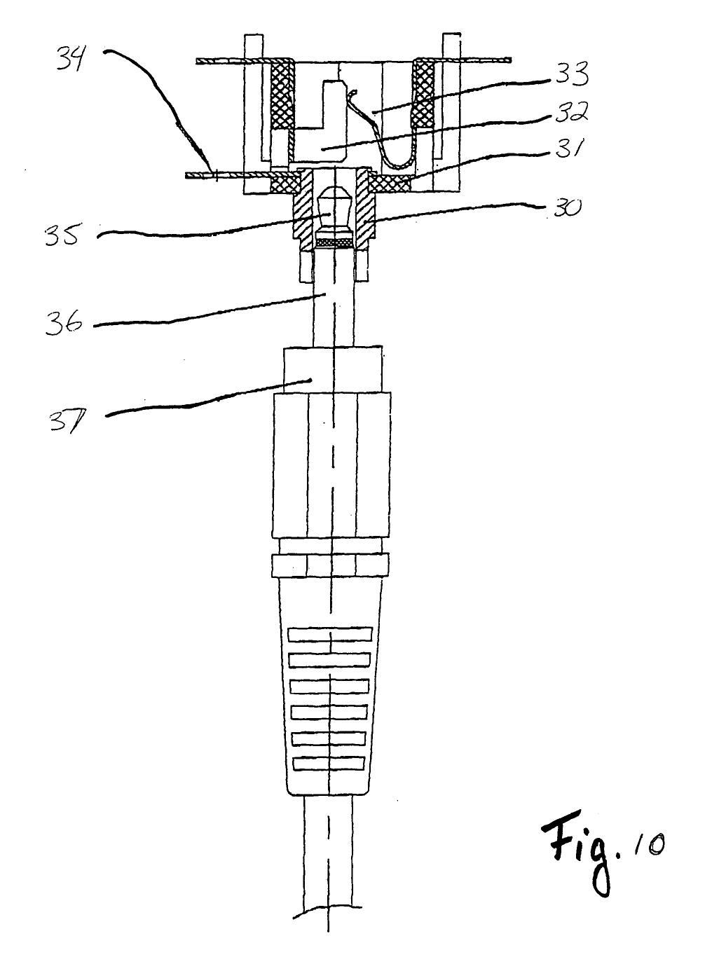

FIG. 8 cross-section view of flashlight head according to invention

FIG. 9 flashlight switch

The charging socket pursuant to FIG. 1 has a socket body 1 with an electric conducting plate 2. One end of the electric conducting plate 2 protrudes at the flashlight body side, and another end of the electric conducting plate protrudes at the flashlight head side, from the socket body 1. The socket body has a slot 7, in which an earth conducting plate 4 is located. The slot 7 also accommodates an electric conducting pin 3 which points in parallel fashion to two slot walls (not shown) in the direction of the slot opening. A corresponding plug can be affixed to the pin 3. The positive contact of the plug touches the pin 3. The negative contact of the plug touches the earth conducting plate 4. If the plug is inserted in slanting fashion, no short circuit can be produced.

Pursuant to FIG. 2 and FIG. 3, the earth conducting plate is designed as a curved metal strip. One end of the earth plate 4 protrudes from the socket body at the slot opening side, another end of the earth plate 4 is located in the slot 7 of the socket body 1. The other end of the earth plate has a spring 5 which points in the direction of the electric conducting pin 3. The spring 5 is arranged integrally in the earth plate. Two rims of the strips at the other end are curved in towards the curved end. The other end of the strip can be clamped into the slot 7.

FIG. 4 shows the slot 7 of the charging socket. The electric conducting pin 3 is located in the slot 7 on the flashlight body side. In the area of the pin 3, the slot opening comprises a circular segment-shaped enclosure for the corresponding plug. Between the electric conducting pin 3 and the wall of the socket body on the flashlight body side, a support 7a is contained integrally in the slot 7. The earth plate 4 has been removed. The slot 7 is surrounded at the side of the opening by a groove 7b, which can accommodate a rubber seal 18.

FIG. 5 shows a view of the charging socket on the flashlight body side (in FIG. 4 the view from the right-hand side) with one end 2a of the electric conducting plate 2.

FIG. 6 corresponds to FIG. 1 with the removed earth plate 4 pursuant to FIG. 3.

FIG. 7 shows two side slot walls 7c, which are positioned more closely to each other at the area of the opening side than in the opposite area. The opening side area of the socket body has a partition.

FIG. 8 shows a flashlight with a built-in charging socket. The positive contact of the charging plug can be combined with the electric conducting pin 3. The current flows through the electric conducting pin 3, the electric conducting plate 2, a re-chargeable flashlight battery 19, a flashlight body 20, a flashlight head 14, the earth plate 4 to the negative plug contact. In this manner, the flashlight battery 19 is re-charged. In addition, electricity flows through the re-chargeable flashlight battery 19, the electric conducting plate 2, a press-button switch 15, a spring 12, light-bulb 8, light-bulb holder 10, flashlight head 14 and flashlight body 20. When the flashlight battery 19 is being re-charged, it is possible to switch the flashlight on and off by means of the press-button switch 15.

The flashlight contains the light-bulb 8, a light-bulb cover 9, the light-bulb holder 10, an insulating socket 11, the spring 12, a switch cover 13, a flashlight head 14, a press-button switch 15, a waterproofing seal 16, a switch-holder 17, the socket body 1, the earth plate 4, the rubber seal 18, the re-chargeable flashlight battery 19 and the flashlight body 20.

FIG. 9 is a schematic diagram of the flashlight switch. There are two electric circuit: One over the light-bulb 8, the flashlight head 14, the flashlight body 20, the flashlight battery 19 and the electric conducting plate 2, the other over the plug which is supplied by a current source 21, the pin 3, the electric conducting plate 2, the flashlight battery 19, the flashlight body 20 and the earth plate 4.

1. Charging socket for a flashlight with a slot (7) in a socket body (1), in which an electric conducting pin (3), which is connected electrically to an electric conducting plate (2) affixed in the body (1), and an earth plate are located.

2. Charging socket according to claim 1, characterised in that the electric conducting pin (3) for insertion in corresponding charging plug points towards the opening of the slot and two ends of the electric conducting plate (2) protrude from two walls of the socket body (1).

3. Charging socket according to claim 1 or 2, characterised in that one end (6) of the earth plate (4) protrudes at the side of the slot opening.

4. Charging socket according to one or more of the aforementioned claims, characterised in that the slot (7) is restricted by two side walls (7b).

5. Charging socket according to claim 4, characterised in that the two side walls (7b) stand closer to each other at the side of the slot opening than at the opposite side of the slot.

6. Charging socket according to one or more of the aforementioned claims, characterised in that a support (7a) for the earth plate (4) is located between the two side walls of the slot (7b).

7. Charging socket according to one or more of the aforementioned claims, characterised in that the electric conducting plate (2) has a longitudinal strip, the ends of which are curved and protrude from the socket body (1).

8. Charging socket according to one or more of the aforementioned claims, characterised in that the earth plate (4) has a curved metal strip, one end of which (6) is curved and protrudes from the slot at the opening side, and the other end is located in the slot (7). The other end has curved in rims and a spring (5) which points towards the pin (3).

9. Charging socket according to one or more of the aforementioned claims, characterised in that the socket body (1) has a wall on the flashlight body side and on the flashlight head side, both of which are positioned transversally to the two slot walls (7b), and in that one end of the electric conducting plate protrudes from the wall at the flashlight body side and the other end protrudes from the wall at the flashlight head side.

10. Charging socket according to one or more of the aforementioned claims, characterised in that the electric conducting pin (3) is located adjacently to the earth plate (4).

11. Charging socket according to one or more of the aforementioned claims, characterised in that the socket body (1) is injection moulded.

12. Charging socket according to one or more of the aforementioned claims, characterised in that the electric conducting needle (3) and the electric plates (2) can be firmly accommodated in the body (1) by means of injection moulding.

13. Flashlight with a flashlight body, which has a socket opening and a charging socket located in the flashlight body (20), according to one or more of the aforementioned claims, characterised in that the slot opening and the socket opening are arranged one above the other and one end of the electric conducting plate (2) is connected to a flashlight battery pole of a suitable flashlight battery (20), and the other end of the electric conducting plate (2) to a flashlight switch (15).

14. Flashlight according to claim 11, characterised in that an electric circuit can be switched on via the electric conducting plate (2) by means of the flashlight switch (15), and that the electric conducting pin (3) and the earth conducting plate (4) are positioned in such a manner that the corresponding charging socket inserted switches on a second electric circuit to charge the flashlight battery (19) via the earth conducting plate (4), the electric conducting pin (3) and the electric conducting plate (2).
